(19) United States
(12) Patent Application Publication
(10) Pub. No.: US 2026/0332216 A1
(43) Pub. Date: Oct. 22, 2026

(54) TYPE 3 TRAINING FOR AI ENABLED CSI FEEDBACK

(71) Applicant: APPLE INC., Cupertino, CA (US)

(72) Inventors: Weidong Yang, San Diego, CA (US); Dawei Zhang, Saratoga, CA (US); Chunxuan Ye, San Diego, CA (US); Wei Zeng, San Diego, CA (US); Parvathanathan Subrahmanya, Sunnyvale, CA (US); Huaning Niu, San Jose, CA (US); Seyed Ali Akbar Fakoorian, San Diego, CA (US)

(21) Appl. No.: 19/122,115

(22) PCT Filed: Nov. 2, 2023
(86) PCT No.: PCT/US2023/078462

§ 371 Date: Apr. 17, 2025

Related U.S. Application Data
(60) Provisional application No. 63/382,282, filed on Nov. 3, 2022.

(51) Int. Cl. H04B 7/06; G06N 3/0455

(52) U.S. Cl. CPC H04B 7/0626; G06N 3/0455

(57) ABSTRACT

Methods and apparatus are provided for Type 3 training for artificial intelligence (AI) enabled channel state information (CSI) feedback. A user equipment (UE) obtains a decoder model-ID from a network for the CSI feedback, determines an encoder model according to the decoder model-ID or including the decoder model-ID as an input to the AI encoder, and feeds a latent space representation for CSI feedback.

### TECHNICAL FIELD

This application relates generally to wireless communication systems, including channel state information (CSI) feedback using artificial intelligence (AI) and/or machine learning (ML).

### BACKGROUND

Wireless mobile communication technology uses various standards and protocols to transmit data between a base station and a wireless communication device. Wireless communication system standards and protocols can include, for example, 3rd Generation Partnership Project (3GPP) long term evolution (LTE) (e.g., 4G), 3GPP new radio (NR) (e.g., 5G), and IEEE 802.11 standard for wireless local area networks (WLAN) (commonly known to industry groups as Wi-Fi®).

As contemplated by the 3GPP, different wireless communication systems standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1A illustrates a UE side training and network side training using Type 3 collaboration in a case with multiple UEs in accordance with some embodiments.

FIG. 1B illustrates a UE side training and network side training using Type 3 collaboration in a case with multiple NWs in accordance with some embodiments.

FIG. 2A illustrates an encoder and decoder design of a first UE from a first UE vendor in accordance with some embodiments.

FIG. 2B illustrates an encoder and decoder design of a second UE from a second UE vendor in accordance with some embodiments.

FIG. 2C illustrates the training datasets used by the network side in accordance with some embodiments.

FIG. 2D illustrates an encoder and decoder design of a first NW 222 from a first NW vendor in accordance with some embodiments.

FIG. 2E illustrates an encoder and decoder design of a second NW 224 from a second NW vendor in accordance with some embodiments.

FIG. 2F illustrates the training datasets used by the UE side in accordance with some embodiments.

FIG. 3 illustrates a latent space representation between an encoder and a decoder that may be used with certain embodiments.

FIG. 4 illustrates possible mappings that different UE vendors may perform between an input to an encoder and a latent space representation.

FIG. 5 illustrates a training dataset indication in accordance with some embodiments.

FIG. 6 illustrates a training dataset indication according to another embodiment.

FIG. 7 illustrates a method for a network node in accordance with some embodiments.

FIG. 8A illustrates a method for a UE in accordance with some embodiments.

FIG. 8B illustrates an example processing flow post training stage in accordance with some embodiments.

FIG. 8C illustrates an example processing flow post training stage accordance with some embodiments.

FIG. 9 illustrates an example architecture of a wireless communication system, according to embodiments disclosed herein.

FIG. 10 illustrates a system for performing signaling between a wireless device and a network device, according to embodiments disclosed herein.

### DETAILED DESCRIPTION

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any appropriate electronic component.

There are several issues in Type 3 training for artificial intelligence (AI) enabled channel state information (CSI) feedback. Specifically, there are issues regarding multiple vendor training. Embodiments herein provide solutions for Type 3 training for AI enabled CSI feedback.

In CSI compression using a two-sided model, various AI/machine learning (ML) model training collaboration Types may be used. Collaboration Type 1 includes joint training of the two-sided model at a single side/entity (e.g., UE-sided or Network-sided). Collaboration Type 2 includes joint training of the two-sided model at network side and UE side, respectively. Collaboration Type 3 includes separate training at network side and UE side, where the UE-side CSI generation part for inference and the network-side CSI reconstruction part for inference are trained by UE side and network side, respectively. In joint training, the generation model and reconstruction model may be trained in the same loop for forward propagation and backward propagation. Joint training may be performed at single node or across multiple nodes (e.g., through gradient exchange between nodes). Separate training includes sequential training starting with UE side training, or sequential training starting with network (NW) side training, or parallel training at UE and NW sides. Other collaboration types are not excluded.

For Type 3 collaboration (separate training at the NW side and the UE side), sequential training starting with UE side training (UE-first training) may include the following. In an example UE first training, the UE side trains the UE side CSI generation part and the UE side CSI reconstruction part (which is not used for inference) jointly.

After the UE side training is finished, the UE side may share a set of information (e.g., dataset) with the NW side that is used by the NW side to be able to train the CSI reconstruction part which is eventually used for inference. The NW side may train the NW side CSI reconstruction part based on the received set of information. While this example UE-first training procedure may be improved based on embodiments herein, other Type 3 UE-first training approaches are not precluded from incorporating the improvements herein.

For Type 3 collaboration, the following procedure may be used for the sequential training starting with NW side training (NW-first training). In an example NW-first training, the NW side trains the NW side CSI generation part (which is not used for inference) and the NW side CSI reconstruction part jointly. After the NW side training is finished, the NW side may share a set of information (e.g., dataset) with the UE side that is may be used by the UE side to be able to train the UE side CSI generation part which is eventually used for inference. The UE side may train the UE side CSI generation part based on the received set of information. While this example NW-first training procedure may be improved based on embodiments herein, other Type 3 NW-first training approaches are not precluded from incorporating the improvements herein.

There may be scenarios where there are one or more UE vendors and one or more infrastructure vendors in the training process and/or inference process. This may lead to several different scenarios to employ Type 3 collaboration. For example, a first case to consider for Type 3 collaboration may be a single UE-side model and a single NW-side model. A second case to consider for Type 3 collaboration may be a single UE-side model and multiple NW-side models. A third case to consider for Type 3 collaboration may be multiple UE-side model and a single NW-side model. A fourth case to consider for Type 3 collaboration may be multiple UE-side models and multiple NW-side models.

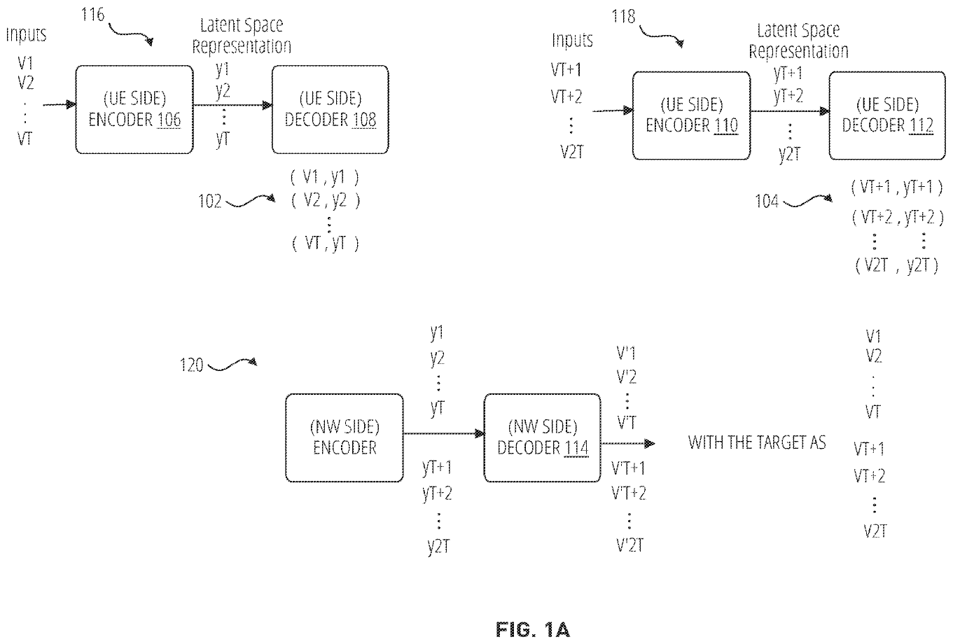

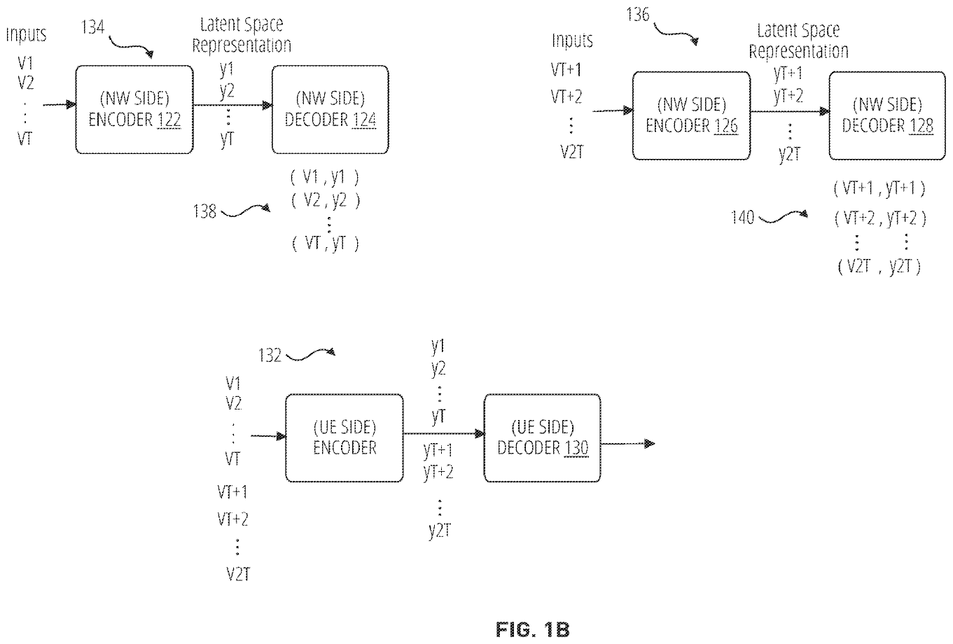

FIG. 1A illustrates a UE side training and network side training using Type 3collaboration in accordance with some embodiments. In the illustrated embodiment, two UEs (e.g., first UE 116 and second UE 118) are both trained and provide training data to a network node 120. The first UE 116 and the second UE 118 may be from different vendors or different UE models under the same vendor and the network node 120 may be from yet another vendor. UE 1 and UE 2 may be just short-hands for UE vendors and may not necessarily be associated with actual UEs.

As shown, the first UE 116 generates a training data set 102. The training data set 102 may include a set of inputs and latent space representations. The first UE 116 may train its encoder 106 and its decoder 108. The first UE 116 may share the training with the network node 120. In the illustration, T samples of training data are included in the training data set.

The second UE 118 may also generate a training data set 104. The training data set 104 may include a set of inputs and latent space representations. The second UE 118 may train its encoder 110 and its decoder 112. The second UE 118 may share the training data set 104 with the network node 120.

The network node may use both training data sets to train its decoder 114. As shown, the latent space representation values from both the first UE 116 and the second UE 118 may be used as an input for the decoder 114. The network node 120 trains the decoder 114 to target an output that matches the inputs of the first UE 116 and the second UE 118. The goal is that the network node 120 may use AI to recover precoders to properly decode data from both the first UE 116 and the second UE 118. In the illustration, T samples of training data are included in the training data set for UE 2, which is the same as for that for UE 1. In practice the size of training data set from each UE vendor and/or UE model may not be exactly the same.

FIG. 1B illustrates a UE side training and network side training using Type 3 collaboration in a case with multiple NWs in accordance with some embodiments. In the illustrated embodiment, two UEs (e.g., first NW 134 and second NW 136) are both trained and provide training data to a UE 132. The first NW 134 and the second NW 136 may be from different vendors or different NW models under the same vendor and the UE 132 may be from yet another vendor. NW 1 and NW 2 may be just short-hands for NW vendors and may not necessarily be associated with actual network nodes.

As shown, the first NW 134 generates a training data set 138. The training data set 138 may include a set of inputs and latent space representations. The first NW 134 may train its encoder 122 and its decoder 124. The first NW 134 may share the training with the UE 132. In the illustration, T samples of training data are included in the training data set.

The second NW 136 may also generate a training data set 140. The training data set 140 may include a set of inputs and latent space representations. The second NW 136 may train its encoder 126 and its decoder 128. The second NW 136 may share the training data set 140 with the UE 132.

The network node may use both training data sets to train its decoder 114. As shown, the latent space representation values from both the first NW 134 and the second NW 136 may be used as an input for the decoder 130. The UE 132 trains the decoder 114 to target an output that matches the inputs of the first NW 134 and the second NW 136. The goal is that the UE 132 may use AI to recover precoders to properly decode data from both the first NW 134 and the second NW 136. In the illustration, T samples of training data are included in the training data set for NW 2, which is the same as for that for NW 1. In practice the size of training data set from each NW vendor and/or NW model may not be exactly the same.

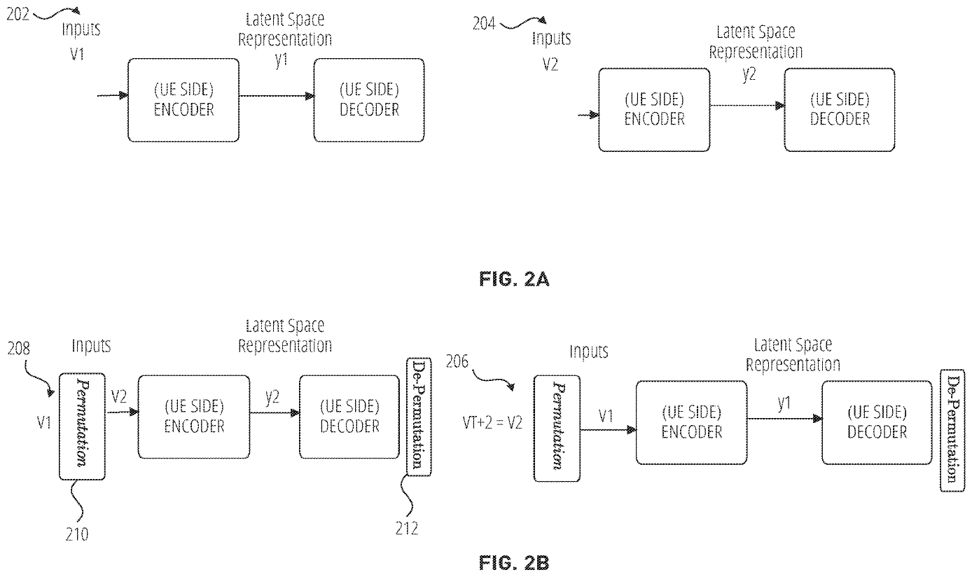

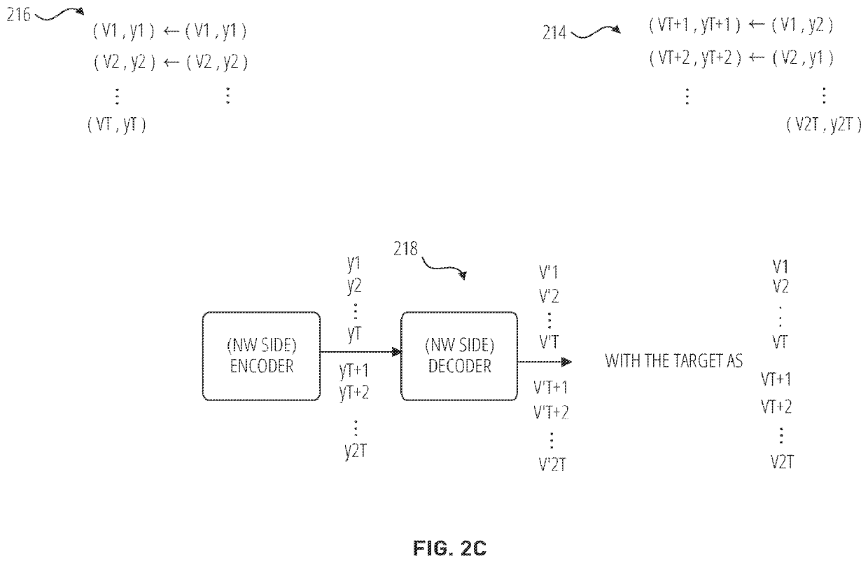

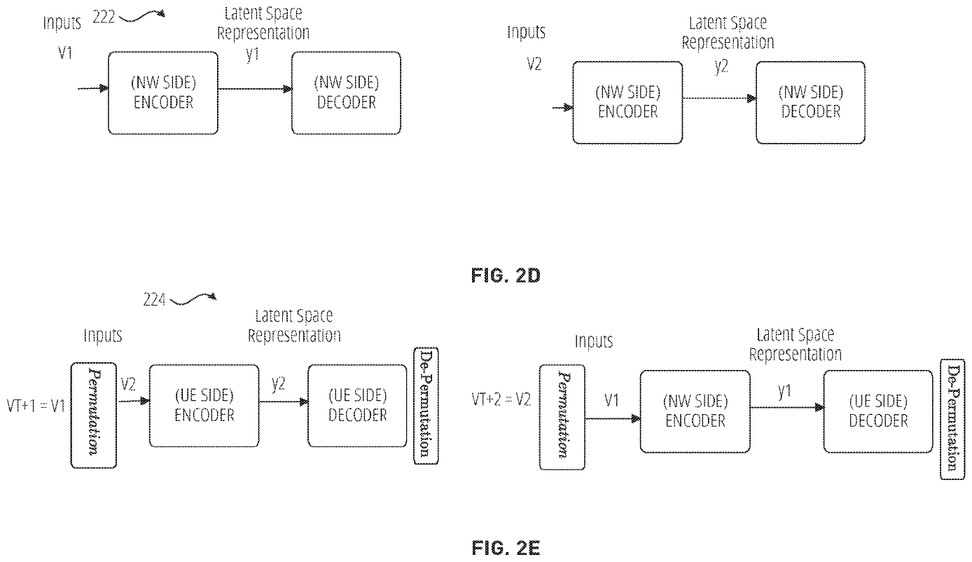

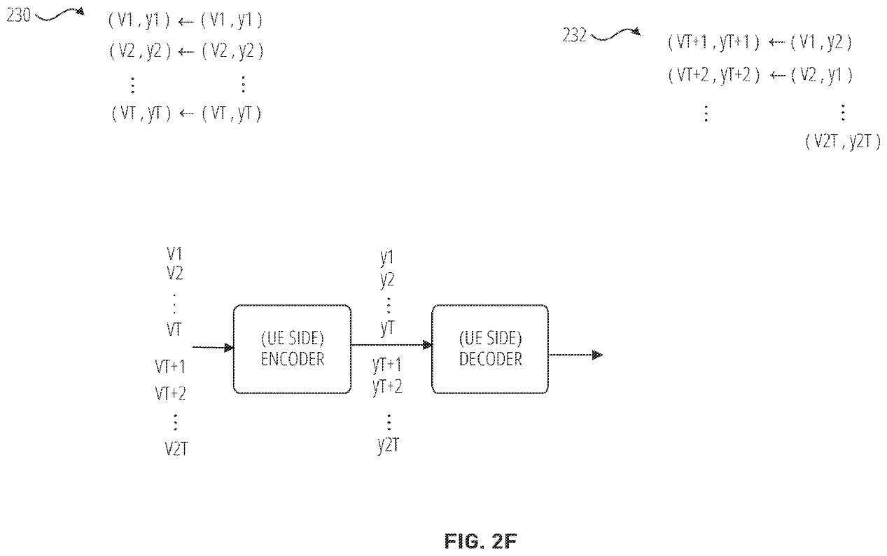

FIG. 2A and FIG. 2B illustrate an example where there can be systematic conflicting latent space representations. FIG. 2A illustrates an encoder and decoder design of a first UE from a first UE vendor. FIG. 2B illustrates an encoder and decoder design of a second UE from a second UE vendor. In the illustrated embodiment much of the encoder/decoder design may be assumed to be identical between the two UE vendors to highlight the issue of systematic conflicting/colliding latent space representations. If the encoder/decoder design are not identical between the two UE vendors, the issue of conflicting/colliding latent space representations may be less severe, mitigating its occurrence is still beneficial and desirable.

For UE vendor 1, shown in FIG. 2A, inputs (input V₁ 202 and input V₂ 204) from antenna ports are mapped in certain order (e.g., with N₁ antenna ports in a first dimenation, and N₂ antenna ports in a second dimenation, P polarizations in the base station antenna array antenna ports, are indexed in the vertical domain first, then the horizontal domain, then in the polarizations. Other orders are also possible by shuffling the mapping sequence) to the inputs of neural network. In the example embodiment, V₁ 202 may be a 64×1 vector (e.g., with 32 Tx ports with I/Q samples). V₂ 204 may be another 64×1 vector (e.g., with 32 Tx ports with I/Q samples for a neural network operating on real numbers), which can be generated from V₁ 202.

For example, v₂(k) may be equal to V₁(65−k), k=1, . . . , 64. In other words, the V₂ 204 input may be reverse of the V₁ 202 input. V₁ 202 and V₂ 204 as well as latent space representation y₁ and y₂ may be used as training data for a network side decoder. Other permutation schemes can be also considered. In one example, only the antenna indexing is modified yet the I/Q sample mapping is not swapped as in the previous example: V₂(k) =V₁(q), for (k,q)=(1,63),(2,64),(3,61),(4,62),(5,59),(6,60),(7,57),(8,58),(9,55),(10,56),(11,53),(12,54),(13,51),(14,52),(15,49),(16,50),(17,47),(18,48),(19,45),(20,46),(21,43),(22,44),(23,41),(24,42),(25,39),(26,40),(27,37),(28,38),(29,35),(30,36),(31,33),(32,34),(33,31),(34,32),(35,29),(36,30),(37,27),(38,28),(39,25),(40,26),(41,23),(42,24),(43,21),(44,22),(45,19),(46,20),(47,17),(48,18),(49,15),(50,16),(51,13),(52,14),(53,11),(54,12),(55,9),(56,10),(57,7),(58,8),(59,5),(60,6),(61,3),(62,4),(63,1),(64,2). The treatment below can be applicable to complex-valued neural network which operate with complex numbers as well. If the neural network operates with complex numbers, V₁ 202 may be a 32×1 vector (e.g., with 32 Tx ports with complex numbers for I/Q samples). V₂ 204 may be another 32×1 vector (e.g., with 32 Tx ports with complex numbers for I/Q samples for a neural network operating on complex numbers), which can be generated from V₁ 202. For example, v₂(k) may be equal to V₁(33−k), k=1, . . . , 32. In other words, the V₂ 204 input may be reverse of the V₁ 202 input. V₁ 202 and V₂ 204 as well as latent space representation y₁ and y₂ may be used as training data for a network node. As similar treatment for real-valued neural network can be pursued, the treatment for complex-valued neural network is omitted for brevity.

In FIG. 2A, latent space representation y₁ is generated in response to the input V₁; latent space representation y₂ is generated in response to the input V₂. And the two pairs of input/latent space representation can be denoted as (V₁, y₁) and (V₂, y₂).

Ideally with the latent space representation (e.g., y₁), the output by the AI decoder should match the input to the UE-side encoder (e.g., V₁). However, inevitably there can be loss in the recovery process, and the output by the AI decoder may not match the input to UE-side encoder precisely. For a properly designed AI-CSI feedback scheme, the output of the AI decoder should be a good approximation to the input to UE-side encoder.

For UE vendor 2, shown in FIG. 2B, inputs (input V₁ 208 and input V₂ 206) from antenna ports are mapped in reverse order (permutation) before entering other part of the neural network. In the example embodiment, V₁ 208 may be a 64×1 vector (e.g., with 32 Tx ports with I/Q samples). V₂ 206 may be another 64×1 vector (e.g., with 32 Tx ports with I/Q samples), which can be generated from V1208. For example, v2(k) may be equal to V₁(65−k), k=1, . . . , 64. In other words, the V₂ 206 input may be reverse of the V₁ 208 input. V₁ 208 and V₂ 208 as well as latent space representation y₁ and y₂ may be used as training data for a network node. Denote the permutation operation 210 as π(x), then π(V₁)=V₂, and π(V₂)=V₁.

UE vendor 2's encoder is assumed to be identical to UE vendor 1's in this example, except for the permutation operation 210. UE vendor 2's decoder is assumed to be identical to UE vendor 1's except for the de-permutation operation 212. Permutation operation 210 and de-permutation operation 212 can be treated as examples for preprocessing and post-processing of AI model inference or as examples for preprocessing and post-processing for AI model inference, which may or may not be included as part of an AI model. FIG. 2C illustrates the training datasets used by the network side. As shown, training dataset 216 may be sent from the first UE from the first vendor, and training dataset 214 may be sent from the second UE from the second vendor.

In FIG. 2B, latent space representation y₂ is generated in response to the input V₁ which leads to V₂ being fed to the UE side encoder after the permutation operation; latent space representation y₁ is generated in response to the input V₂ which leads to V₁ being fed to the UE side encoder after the permutation operation. And the two pairs of input/latent space representation can be denoted as (V₂, y₁) and (V₁, y₂).

The four pairs ((V₁, y₁), (V₂, y₂), (V₁, y₂)) and (V₂, y₁) ) (V₁, y₂))may be used as part of training dataset for the NW-side decoder. For output of the NW-side decoder, in the training dataset 216 from UE vendor 1, given the latent space representation y₁, UE vendor 1 expects V₁; given the latent space representation y₂, UE vendor 1 expects V₂. In contrast, for output of the NW-side decoder in the training dataset 214 from UE vendor 2, given the latent space representation y₁, UE vendor 2 expects V₂; given the latent space representation y₂, UE vendor 2 expects V₁. If training data is treated in a vendor-agnostic way, then training data with conflicting latent space representations exemplified by the four pairs may lead to the breakdown of training the network decoder 218 wherein the trained network decoder has difficulty to recover two different inputs for the two UE vendors when they use the same latent space representation to represent different values.

If a network first approach is considered, if a single network vendor provides training data to two or more UE vendors, the conflicting latent space representation may be avoided. For instance if the infrastructure vendor generates the training data and shares the training data with the UEs from different vendors, then the problem with conflicting latent space representations may be avoided.

Use of Type 3 collaboration between one or more UE vendors (i.e., on the UE side) and one or more infrastructure (infra) vendors (i.e., on the network side) may lead to training breakdown. For example, without specifying the inputs to the neural network encoder, Type 3 training may break down for multiple UE-vendors, single NW vendor setup. However, even if the inputs to the neural network encoder are specified, there can be still a systematic mis-labelling problem between vendors.

In a first example case (Case 1), UE first training for the setup with multiple UE-vendors and a single NW Type 3 training may break down for the (multiple UE-vendors, single NW vendor) setup, because there can be systematic conflicting latent space representations among UE vendors. This is disused with reference to FIG. 2A-FIG. 2C.

In a second example case (Case 2) with network first training for the setup with multiple UE-vendors, and single network vendor, the systematic mis-labeling problem may be avoided in certain circumstances.

In a third example case (Case 3) with UE first training for the setup with a single UE-vendor and multiple network vendors, systematic mis-labeling may not be a problem.

In a fourth example case (Case 4) with network first training for the setup with a single UE-vendor and multiple network vendors, Case 4 may include the same problems as in Case 1 because infrastructure vendors may generate systematic mis-labeling and/or conflicting latent space representations for the same UE vendor (e.g., the four pairs ((V₁, y₁), (V₂,y₂), (V₁,y₂) and (V₂, y₁)) may arise as shown in FIGS. 1B, 2D, 2E and 2F under a similar situation as illustrated in FIGS. 1A, 2A, 2B and 2C by swapping the roles of NW and UE).

For example, FIG. 2D and FIG. 2E illustrate an example where there can be systematic conflicting latent space representations. FIG. 2D illustrates an encoder and decoder design of a first NW 222 from a first NW vendor. FIG. 2E illustrates an encoder and decoder design of a second NW 224 from a second NW vendor. FIG. 2F illustrates the training datasets used by the UE side. As shown, training dataset 230 may be sent from the first NW from the first NW vendor, and training dataset 232 may be sent from the second NW from the second NW vendor. NW vendors/Infrastructure vendors may generate systematic mis-labeling and/or conflicting latent space representations for the same UE vendor (e.g., the four pairs ((V₁, y₁), (V₂, y₂), (V₁, y₂) and (V₂, y₁)).

A fifth example case (Case 5) may include the setup with multiple UE-vendors, multiple network vendors. There may be numerous combinations/possibilities for Case 5. In certain embodiments, a training schedule can be used, with atomically correct steps such as Case 2 and Case 3 processing. In other words, in certain embodiments, the composition of Case 5's training schedule may be limited to the use of Case 2 and Case 3 (one or both can be utilized more than once). However, the effect of the training schedule may be uncertain. If the number of iterations is small, the sequencing of Case 2 and/or Case 3 processing in training schedule may have an impact non-uniformly to performance of different pairs (UE-side encoder, NW-side decoder) (e.g., among the vendors or pairs of (UE-side encoder, NW-side decoder), whoever starts first in the training schedule has advantage over others). If the process can go for tens of iterations and/or if the training schedule is randomized, the training schedule may or may not have an impact, in some cases addressing the mislabeling issue with multiple iterations of training may not be desirable logistically.

In some embodiments, for Case 5, the training schedule may be a mixture of the procedures used in Case 2 and Case 3. For example, a network first training may be used for a first vendor, a UE first training may be used for a second vendor, a network first training may be used for a third vendor, a UE first training may be used for a fourth vendor, with the pattern repeating for all the vendors.

### Neural Network and Continuous Functions

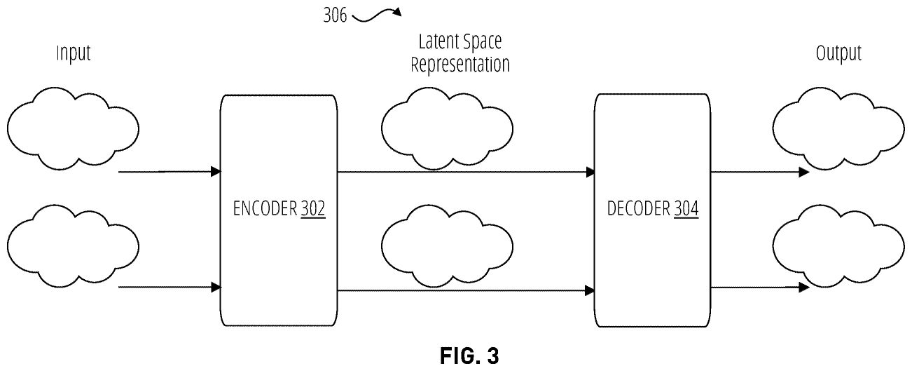

FIG. 3 illustrates a latent space representation 306 between an encoder 302 and a decoder 304 that may be used with certain embodiments. The latent space representation conceptually may be like a hash generated for a specific input. Even with hundreds of bits for the latent space representation, the number of different inputs may be still much larger than the number of different latent space representation due to the auto-encoder processing. Consequently, the mapping from input to latent space representation (e.g., f_{UE-vendor-ID}(V)→y), may be a many-to-one mapping as for a hash function. It is noted that each vendor may use a unique mapping function from an input (e.g., a subband precoder) to a latent space representation 306. Factors affecting the mapping function generation through the weights/bias of neural networks include the neural network architecture (e.g., CNN or transformer), the number of attention heads in a transformer, training hyperparameters such as the learning rate, the number of training epochs/iterations, and the batch size, and the training dataset, etc., and any or all of them can lead to difference in the trained neural networks (thus the mapping function from inputs to latent space representations). Then one, some or all aspects of them can be referred to differentiate different UE vendors' AI models in the generation of a latent space representation, e.g., to explicitly or implicitly consider the UE vendor/UE model through a UE-vendor-ID/dataset ID/dataset Type ID/AI model ID. Note the difference in the mapping of {inputs, latent space representations, outputs} from different vendors can be characterized in different ways, e.g., as different neural networks can be different, the difference can be characterized as in the AI model itself. Accordingly, in some embodiments, the training may consider a dataset ID, a vendor ID, UE-model ID or even a AI model ID for its/their eventual use or reference in the inference state.

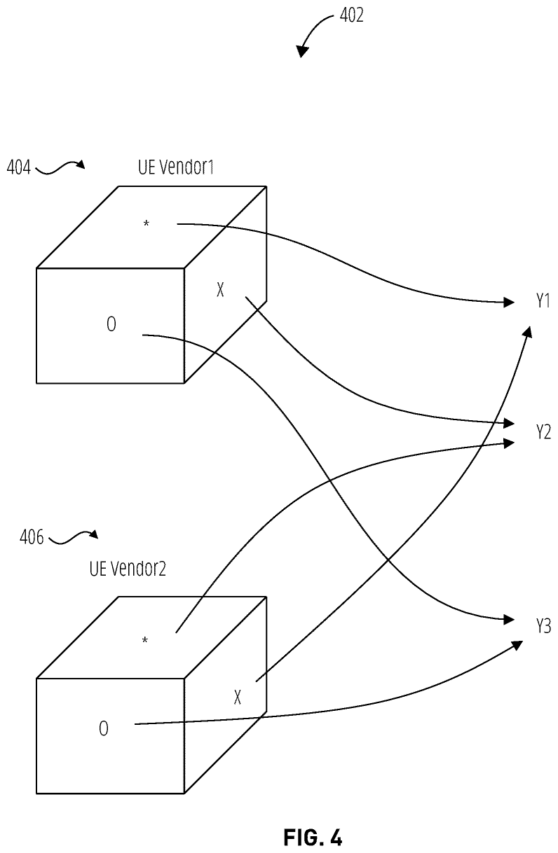

FIG. 4 illustrates possible mappings 402 that different UE vendors (shown as UE Vendor1 404 and UE Vendor2 406) may perform between an input to an encoder and a latent space representation. When using UE first training, each UE vendor may use (potentially different) mapping functions to perform the mapping between input and a latent space representation. There may be confusion/collision among hash functions (e.g., text-1's hash by hash function 1 is the same as text-2's hash by hash function 2). The same may happen between different UE vendors' encoders as illustrated in FIG. 4. In the example shown in FIG. 4, “*”, “X” and “O” represent different inputs (e.g., each is a 64 by 13 real matrix for subband eigen-vectors over 13 subbands with 32 antenna ports), Y1, Y2, Y3 are latent space representations, but UE Vendor1 404 and UE Vendor2 406 assign them different meanings for Y1 and Y2.

### Systematic Conflicting Latent Space Representation Problem

Confusion or collision between labels from different UE vendors may be expected The net result may be conflicting training data. The infra vendor's decoder model may output v1 in response to y1 (to the advantage of UE vendor 1) or may output v2 in response to y1 (to the advantage of UE vendor 2), or neither of them. If its occurrence frequency is low, the collision between labels may be tolerable. If it happens frequently, then it may cause a problem.

The confusion/collision problem may get worse with more UE vendors. Even from the same UE vendor, there may be different UE products with non-identical AI engines for the UE phone models (e.g., with a life time of 8 years, and 4 UE phone models per year, even a single UE vendor may have multiple AI models for its phone models). To mitigate the issue of conflicting/colliding labels, it may be tempting to use an identical AI model for UEs from the same UE vendor. However, there may be limited room to sync up AI models residing in different UE phone models (e.g., hardware/firmware may be different at different UE phone models). From the discussion, it can be seen it may not be practical for a UE vendor to train a single universal UE-side encoder which works with NW-side decoders from all NW vendors; and it may not be practical for a NW vendor to train a single universal NW-side decoder which works with UE-side encoders from all UE vendors.

### Training Dataset Indication

It is noted at the training stage, both the UE side and the NW side are aware of the source(s) of training data sets and the NW node performing the NW-side decoder training. Once an AI model is deployed, e.g., a UE-side encoder or a NW-side decoder is deployed, the current air interface design such as from 3GPP may not provide a means for a UE to identify which NW vendor's base station is in use} or which NW vendor's NW-side decoder is in use; also the current air interface design such as from 3GPP may not provide a means for a base station to identify {which UE vendor's UE} or which UE vendor's UE-side encoder is in use. Thus some kind of matching process is needed.

In certain embodiments, instead of treating the training data sets from different UE vendors, UE models, network vendors, and/or network models, as homogenous data, a UE or NW side-AI model ID, label, training dataset ID, training dataset type ID, or name-space may be attached to the training data set. As used herein, “UE vendor” may be replaced with “UE product from a UE vendor” (e.g., Vendor A phone XYZ, Vendor A phone ABC, etc.).

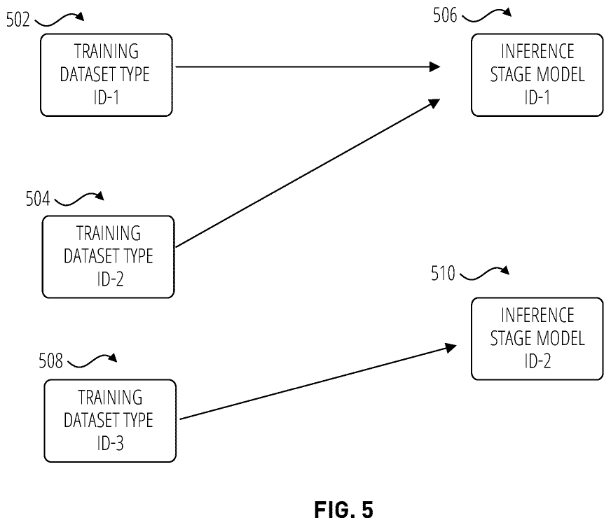

FIG. 5 illustrates a training dataset indication according to one embodiment. In this example, the UE vendor indicates a training data set type ID which may be mapped to or linked to inference stage model ID-1 (AI model ID) in a training dataset sent to an infra vendor/NW vendor. For example, this may be used for the UE vendor to provide additional training data for a deployed AI model. For instance, training dataset type ID-1 502 and training dataset type ID-2 504 may both be mapped to inference stage model ID-1 506. Similarly, training dataset type ID-3 508 may be mapped to inference stage model ID-2 510.

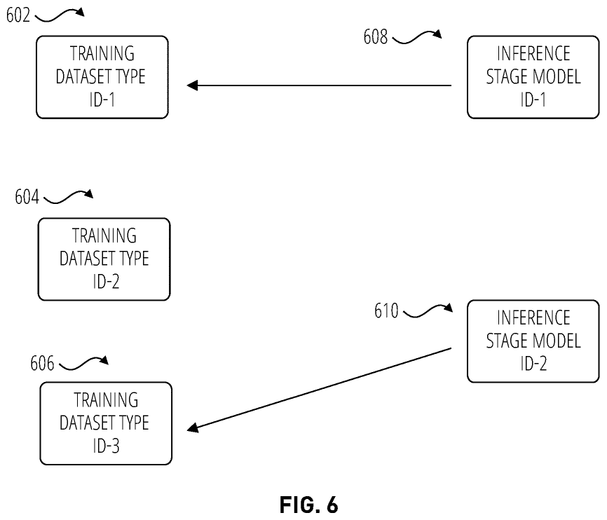

FIG. 6 illustrates a training dataset indication according to another embodiment. In this example, the UE vendor indicates training data set type ID (type ID-1, type ID-2, type ID-3) in a training dataset (training data set 602, training data set 604, and training data set 606) sent to the infra-vendor. In a later stage, when the inference model-ID (inference stage model 608 and inference stage model 610) is established between the UE and the network node, the training dataset type ID may be referred to.

### Second Stage Training-Attachment of Dataset ID (for UE First)

Second stage training for Case 1 collaboration refers to NW side training of its decoder in a UE side first Type 3 training. Second stage training for Case 5 collaboration refers to UE side training of its encoder in a NW side first Type 3 training.

In certain embodiments, to avoid systematic mislabeling, the training dataset is modified by referencing the source of training dataset. One such embodiment adds a prefix, or post-fix to the latent space representation (e.g., [prefix for dataset-ID or UE vendor ID or UE model ID or AI-model ID][latent space representation]). For Case 1, the modified training dataset may be {input to the AI encoder on the UE side (v), ([prefix for dataset-ID][latent space representation])}. In another embodiment, similar to positioning encoding, the dataset-ID or UE vendor ID or UE model ID or AI-model ID may be embedded into the expanded latent space representation.

In certain embodiments, instead of training a single NW-side decoder for training data sets from different UE vendors/UE models, in reality the NW side trains multiple NW-side decoders to handle training data sets from different UE vendors/UE models. Then under a nominally single NW side decoder, there may actually be multiple NW side decoders matched to different training datasets. In some embodiments, the NW side may perform consolidation on the training datasets (e.g., identify those training datasets which don't suffer systematic mislabeling problem among them, or identify training datasets which do suffer from systematic mislabeling problem among them).

### Second Stage Training-Attachment of Dataset-ID (for NW First)

In certain embodiments, to avoid systematic mislabeling, the training dataset is modified by referencing the source of training dataset. One such embodiment adds a prefix, or post-fix to the latent space representation (e.g., [prefix for dataset-ID or NW vendor ID or base station model ID or AI-model ID][latent space representation]). For Case 4, the modified training dataset may include {input to the AI encoder on the NW side (v), ([prefix for dataset-ID or NW vendor ID or base station model ID or AI-model ID][latent space representation])}. In another embodiment, similar to positioning encoding, the dataset-ID or infra vendor ID/NW vendor ID or base station model ID or AI-model ID may be embedded into the expanded latent space representation. It is noted from the same base station vendor, there can be difference among different base station versions/platforms and/or auxiliary equipments such as the antenna modules.

In certain embodiments, instead of training a single UE-side encoder for training data sets from different infra vendors/base station models, the UE side trains multiple encoders in reality. As under a nominally single UE side encoder, there may actually be multiple encoders matched to different training datasets from different NW vendors/base station models. In some embodiments, the UE side may perform consolidation on the training datasets (e.g., identify those training datasets which don't suffer systematic mislabeling problem among them, or identify training datasets which do suffer from systematic mislabeling problem among them).

### Inference Stage-Implicit Reference of Model-ID/dataset ID/dataset Type ID

In certain embodiment, at the inference stage, the CSI feedbacks from two UEs (e.g., a first UE from UE Vendor A, a second UE from UE Vendor B) may carry the same bits for the CSI feedback, but they may correspond to different precoders. Accordingly, at the inference stage, a model-ID may be referenced to differentiate the CSI feedback from the two vendors. The mapping between dataset ID/dataset Type ID and inference stage model-ID as discussed herein may be used.

In some embodiments, the network node may perform the following. For CSI feedback in a CSI reporting configuration, the network node may configure the UE with a neural network model with a model-ID which is linked to training dataset ID. The network node may obtain the latent space representation from the uplink control information (UCI) fed back by a UE. The network node may include the training dataset-ID/training dataset type ID/model-ID and the latent space representation as input to the network node AI decoder, and obtain the target CSI.

### Case 5—Multiple UE Vendor and Multiple Infra Vendor Training

In certain embodiments, in a multiple UE vendors and multiple infra vendor training setup, and the corresponding inference stage, addition, prefix, or post-fix for infra vendor-ID and UE-vendor-ID may be used. On the UE side, there may be multiple AI encoder models (e.g., model-1 for Vendor E, model-2 for Vendor B, etc.). On the NW side (e.g., for a Vendor E base station), there may be multiple AI decoder models (e.g., decoder-model-1 for Vendor C, decoder-model-2 for Vendor A, etc.). Similar to the consideration on UE products (e.g., Vendor A phone XYZ, Vendor A phone ABC), there may be different base station implementations from the same vendor. For example, small cell base station, macro base station, old AI model due to elapse of service agreement or low-cost contract, etc. Thus, the number of encoders a UE stores may be large.

In certain embodiments, for CSI generation to work properly, not only does the UE identify itself, the network also identifies itself. Thus, a UE can properly look up an AI encoder matched to the network or NW-side decoder(s) from a NW vendor (e.g., a network identifies it as “VendorE-2025-xyz”). Hence, in a first step, a UE may obtain one or more network model-ID from the radio network, e.g. from a SIB (System Information Block) message, from RRC signaling, from MAC CE, from dynamic signaling. When carrier aggregation is configured, a network model-ID at one component carrier may be different a network model-ID at another component carrier. With dual connectivity, for component carriers in different cell groups, they may be associated with different network model-IDs. With the network model-ID, after the UE looks up one or more encoder model residing on the UE matched with the network model-ID (e.g., it may look up a model among all the stored encoder models), and informs the network of the outcome of lookup. NW may act according to the provided outcome, e.g., it may configure the UE with CSI feedback, if more than one network model-ID are available, or more than one UE model ID are available, the CSI feedback configuration may contain indication to uniquely select a network model-ID and/or UE model-ID.

In some embodiments, to avoid systematic mislabeling problems (or conflicting latent space representations) in CSI feedback, a UE may be configured to obtain a network (decoder) model-ID from a radio network for CSI feedback. The UE may provide a training data set ID/training dataset type ID/vendor ID/UE model ID/UE side AI-model ID for its encoder model to the network. In some embodiments, the UE may determine an encoder model according to the network model-ID or include the network model-ID as input in its AI encoder. In some embodiments, the UE may feed the latent space representation for CSI feedback. In some embodiments, in a first step, the UE provides one or more UE model-ID to the radio network. When carrier aggregation is configured, a UE model-ID at one component carrier may be different a UE model-ID at another component carrier. With dual connectivity, for component carriers in different cell groups, they may be associated with different UE model-IDs. the network determines a decoder model according to UE model-ID (e.g., the training data ID) or includes UE model-ID (e.g., the training data ID) as input in its AI decoder.

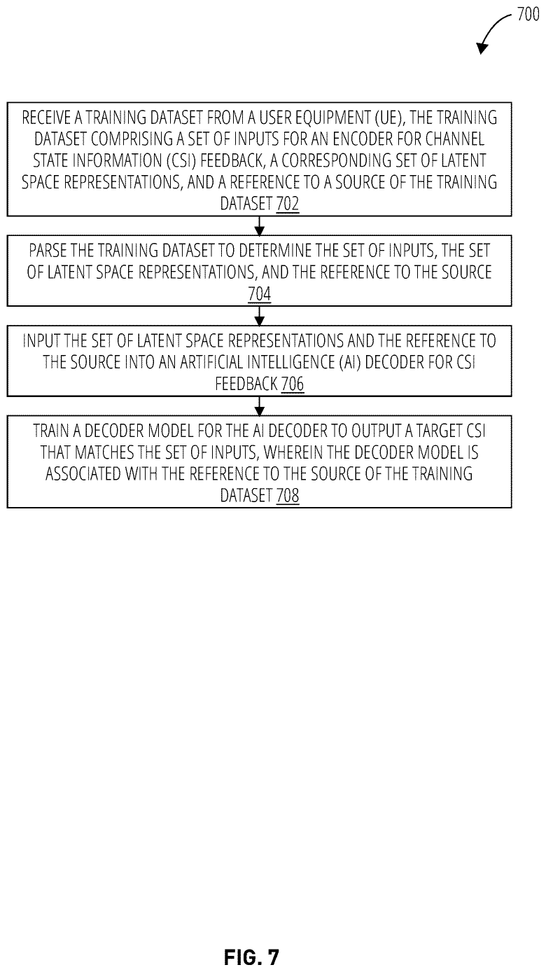

FIG. 7 illustrates a method 700 for a network node for second stage training in a UE first type 3 training. A similar method may be used by a UE for second stage training in a network first type 3 training. As shown, in the illustrated embodiment, the network node receives 702 a training dataset from a UE, the training dataset comprising a set of inputs for an encoder for CSI feedback, a corresponding set of latent space representations, and a reference to a source of the training dataset. The method 700 further includes parsing 704 the training dataset to determine the set of inputs, the set of latent space representations, and the reference to the source. The method 700 further includes inputting 706 the set of latent space representations and the reference to the source into an AI decoder for CSI feedback. In some embodiments the reference to the source may be used to select an AI decoder. The method 700 further includes training 708 a decoder model for the AI decoder to output a target CSI that matches the set of inputs, wherein the decoder model is associated with the reference to the source of the training dataset.

In some embodiments, the reference to the source comprises a dataset-identification (ID).

In some embodiments, the dataset-ID is included as a prefix or a post-fix to the latent space representations.

In some embodiments, the method 700 may further comprise training a second decoder model for the AI decoder based on a second training dataset with a different dataset-ID.

In some embodiments, the method 700 may further comprise mapping the dataset-ID to the decoder model.

In some embodiments, the reference to the source is embedded into the latent space representations.

In some embodiments, the method 700 may further comprise determining a decoder model for the AI decoder based on the reference to the source.

Embodiments contemplated herein include an apparatus comprising means to perform one or more elements of the method 700. This apparatus may be, for example, an apparatus of a base station (such as a network device 1018 that is a base station, as described herein).

Embodiments contemplated herein include one or more non-transitory computer-readable media comprising instructions to cause an electronic device, upon execution of the instructions by one or more processors of the electronic device, to perform one or more elements of the method 700. This non-transitory computer-readable media may be, for example, a memory of a base station (such as a memory 1022 of a network device 1018 that is a base station, as described herein).

Embodiments contemplated herein include an apparatus comprising logic, modules, or circuitry to perform one or more elements of the method 700. This apparatus may be, for example, an apparatus of a base station (such as a network device 1018 that is a base station, as described herein).

Embodiments contemplated herein include an apparatus comprising: one or more processors and one or more computer-readable media comprising instructions that, when executed by the one or more processors, cause the one or more processors to perform one or more elements of the method 700. This apparatus may be, for example, an apparatus of a base station (such as a network device 1018 that is a base station, as described herein).

Embodiments contemplated herein include a signal as described in or related to one or more elements of the method 700.

Embodiments contemplated herein include a computer program or computer program product comprising instructions, wherein execution of the program by a processing element is to cause the processing element to carry out one or more elements of the method 700. The processor may be a processor of a base station (such as a processor(s) 1020 of a network device 1018 that is a base station, as described herein). These instructions may be, for example, located in the processor and/or on a memory of the base station (such as a memory 1022 of a network device 1018 that is a base station, as described herein).

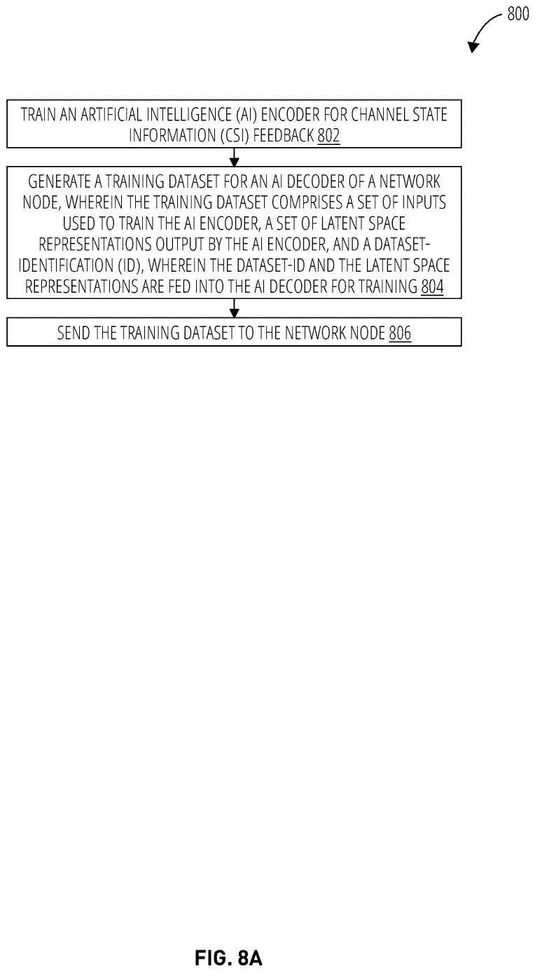

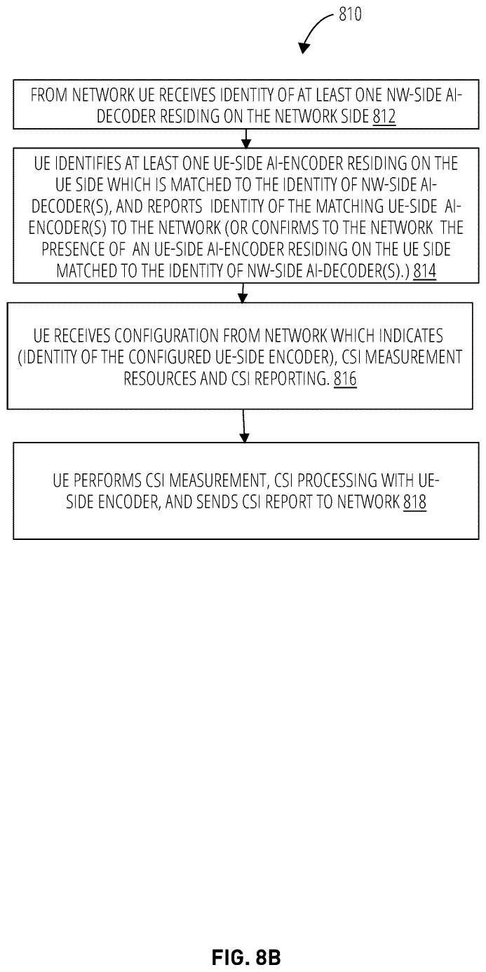

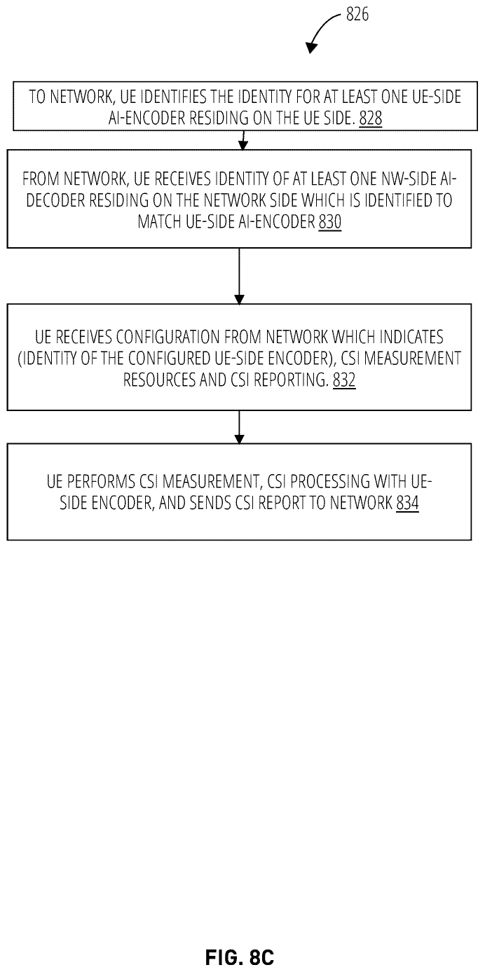

FIG. 8A illustrates a method 800 for a UE for UE first type 3 training. A similar method may be used by a network node for a network first type 3 training. The illustrated method 800 includes training 802 an artificial intelligence (AI) encoder for channel state information (CSI) feedback. The illustrated method 800 further includes generating 804 a training dataset for an AI decoder of a network node. The training dataset comprises a set of inputs used to train the AI encoder, a set of latent space representations output by the AI encoder, and a dataset-identification (ID). The dataset-ID and the latent space representations are fed into the AI decoder for training. The illustrated method 800 sends 806 to a training dataset to the network node.

In some embodiments, the dataset-ID is included as a prefix or a post-fix to the latent space representations.

In some embodiments, further comprising encoding and sending CSI feedback using the AI encoder.

In some embodiments, the method 800 may further comprise receiving, from the network node, a decoder model-ID for CSI feedback.

Embodiments contemplated herein include an apparatus comprising means to perform one or more elements of the method 800. This apparatus may be, for example, an apparatus of a UE (such as a wireless device 1002 that is a UE, as described herein).

Embodiments contemplated herein include one or more non-transitory computer-readable media comprising instructions to cause an electronic device, upon execution of the instructions by one or more processors of the electronic device, to perform one or more elements of the method 800. This non-transitory computer-readable media may be, for example, a memory of a UE (such as a memory 1006 of a wireless device 1002 that is a UE, as described herein).

Embodiments contemplated herein include an apparatus comprising logic, modules, or circuitry to perform one or more elements of the method 800. This apparatus may be, for example, an apparatus of a UE (such as a wireless device 1002 that is a UE, as described herein).

Embodiments contemplated herein include an apparatus comprising: one or more processors and one or more computer-readable media comprising instructions that, when executed by the one or more processors, cause the one or more processors to perform one or more elements of the method 800. This apparatus may be, for example, an apparatus of a UE (such as a wireless device 1002 that is a UE, as described herein).

Embodiments contemplated herein include a signal as described in or related to one or more elements of the method 800.

FIG. 8B illustrates an example processing flow 810 post training stage, for example with case NW-first training is conducted for the training stage. As shown, the network indicates 812 the identity of at least one NW-side AI-decoder, e.g., which can be associated with a training data set ID/training dataset type ID/vendor ID/NW model ID/NW side AI-model ID etc. From the identification, which can be carried in a SIB message or dedicated RRC signaling, in 815, if UE is in possession of a UE-side AI-decoder which is matched to the identity of NW-side AI-decoder, the UE may identify 814 and indicate that to the network. Depending on whether multiple NW-side AI-decoders are identified or a single NW-side AI-decoder is identified; the indication from UE may contain a reference to one of the NW-side AI-decoder. If there are more than one UE-side encoder matched to one or more NW side encoder; the UE may indicate the matched pair (UE side encoder and NW-side decoder) to the network. If there is a unique pair, then the UE may send a confirmation rather than identification to the network. The network may select a NW-side decoder for AI-CSI processing with the UE. Besides CSI measurement resources configuration, the network may indicate 816 the configured UE-side encoder which is matched to the selected NW-side decoder to the UE in the CSI reporting. The UE performs 818 CSI measurement, CSI processing with UE-side encoder, and sends CSI report to network, which may include some ID(s) for the UE-side encoder and/or NW-side decoder.

FIG. 8C illustrates an example processing flow 826 post training stage, for example with case NW-first training is conducted for the training stage. As shown, the UE indicates 828 the identity of at least one UE-side AI-decoder, e.g., which can be associated with a training data set ID/training dataset type ID/vendor ID/UE model ID/UE side AI-model ID etc. From the identification, which can be carried in a UE capability signaling or any dedicated RRC signaling other than UE capability signaling, if NW is in possession of a NW-side AI-encoder which is matched to the identity of UE-side AI-decoder, the NW identifies 830 and indicates that to the UE. Depending on whether multiple UE-side AI-encoders are identified or a single UE-side AI-encoder is identified; the indication from NW may contain a reference to one of the UE-side AI-encoder. If there are more than one NW-side decoder matched to one or more UE side encoder; the NW may indicate the matched pair (UE side encoder and NW-side decoder) to the UE. If there is a unique pair, then the NW may send a confirmation rather than identification to the UE. The network may select a NW-side decoder for AI-CSI processing with the UE. As shown, besides CSI measurement resources configuration, the network may indicate 832 the configured UE-side encoder which is matched to the selected NW-side decoder to the UE in the CSI reporting. The UE performs 834 CSI measurement, CSI processing with UE-side encoder, and sends CSI report to network, which may include some ID(s) for the UE-side encoder and/or NW-side decoder.

Embodiments contemplated herein include a computer program or computer program product comprising instructions, wherein execution of the program by a processor is to cause the processor to carry out one or more elements of the method 800. The processor may be a processor of a UE (such as a processor(s) 1004 of a wireless device 1002 that is a UE, as described herein). These instructions may be, for example, located in the processor and/or on a memory of the UE (such as a memory 1006 of a wireless device 1002 that is a UE, as described herein).

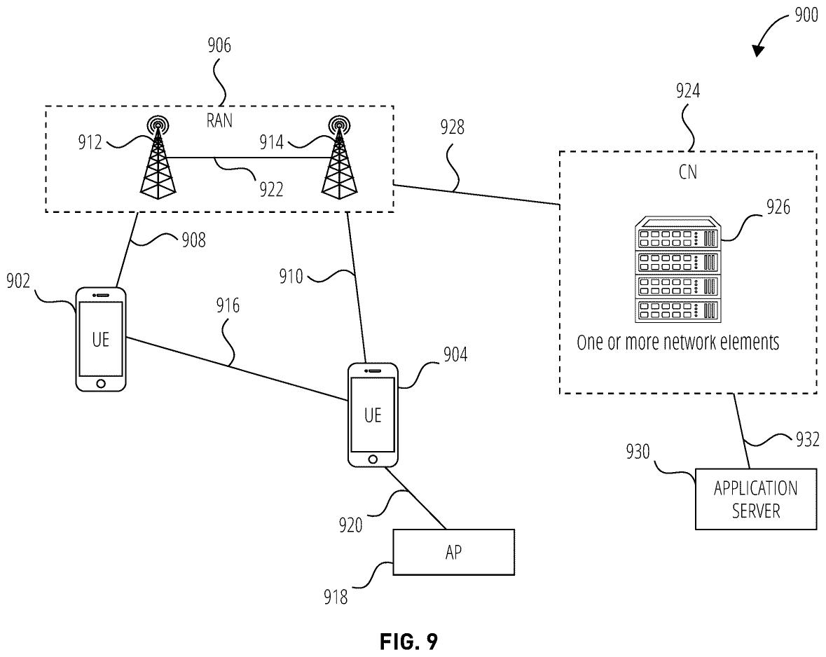

FIG. 9 illustrates an example architecture of a wireless communication system 900, according to embodiments disclosed herein. The following description is provided for an example wireless communication system 900 that operates in conjunction with the LTE system standards and/or 5G or NR system standards as provided by 3GPP technical specifications.

As shown by FIG. 9, the wireless communication system 900 includes UE 902 and UE 904 (although any number of UEs may be used). In this example, the UE 902 and the UE 904 are illustrated as smartphones (e.g., handheld touchscreen mobile computing devices connectable to one or more cellular networks), but may also comprise any mobile or non-mobile computing device configured for wireless communication.

The UE 902 and UE 904 may be configured to communicatively couple with a RAN 906. In embodiments, the RAN 906 may be NG-RAN, E-UTRAN, etc. The UE 902 and UE 904 utilize connections (or channels) (shown as connection 908 and connection 910, respectively) with the RAN 906, each of which comprises a physical communications interface. The RAN 906 can include one or more base stations (such as base station 912 and base station 914) that enable the connection 908 and connection 910.

In this example, the connection 908 and connection 910 are air interfaces to enable such communicative coupling, and may be consistent with RAT(s) used by the RAN 906, such as, for example, an LTE and/or NR.

In some embodiments, the UE 902 and UE 904 may also directly exchange communication data via a sidelink interface 916. The UE 904 is shown to be configured to access an access point (shown as AP 918) via connection 920. By way of example, the connection 920 can comprise a local wireless connection, such as a connection consistent with any IEEE 802.11 protocol, wherein the AP 918 may comprise a Wi-Fi® router. In this example, the AP 918 may be connected to another network (for example, the Internet) without going through a CN 924.

In embodiments, the UE 902 and UE 904 can be configured to communicate using orthogonal frequency division multiplexing (OFDM) communication signals with each other or with the base station 912 and/or the base station 914 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 912 or base station 914 may be implemented as one or more software entities running on server computers as part of a virtual network. In addition, or in other embodiments, the base station 912 or base station 914 may be configured to communicate with one another via interface 922. In embodiments where the wireless communication system 900 is an LTE system (e.g., when the CN 924 is an EPC), the interface 922 may be an X2 interface. The X2 interface may be defined between two or more base stations (e.g., two or more eNBs and the like) that connect to an EPC, and/or between two eNBs connecting to the EPC. In embodiments where the wireless communication system 900 is an NR system (e.g., when CN 924 is a 5GC), the interface 922 may be an Xn interface. The Xn interface is defined between two or more base stations (e.g., two or more gNBs and the like) that connect to 5GC, between a base station 912 (e.g., a gNB) connecting to 5GC and an eNB, and/or between two eNBs connecting to 5GC (e.g., CN 924).

The RAN 906 is shown to be communicatively coupled to the CN 924. The CN 924 may comprise one or more network elements 926, which are configured to offer various data and telecommunications services to customers/subscribers (e.g., users of UE 902 and UE 904) who are connected to the CN 924 via the RAN 906. The components of the CN 924 may be implemented in one physical device or separate physical devices including components to read and execute instructions from a machine-readable or computer-readable medium (e.g., a non-transitory machine-readable storage medium).

In embodiments, the CN 924 may be an EPC, and the RAN 906 may be connected with the CN 924 via an S1 interface 928. In embodiments, the SI interface 928 may be split into two parts, an S1 user plane (S1-U) interface, which carries traffic data between the base station 912 or base station 914 and a serving gateway (S-GW), and the S1-MME interface, which is a signaling interface between the base station 912 or base station 914 and mobility management entities (MMEs).

In embodiments, the CN 924 may be a 5GC, and the RAN 906 may be connected with the CN 924 via an NG interface 928. In embodiments, the NG interface 928 may be split into two parts, an NG user plane (NG-U) interface, which carries traffic data between the base station 912 or base station 914 and a user plane function (UPF), and the S1 control plane (NG-C) interface, which is a signaling interface between the base station 912 or base station 914 and access and mobility management functions (AMFs).

Generally, an application server 930 may be an element offering applications that use internet protocol (IP) bearer resources with the CN 924 (e.g., packet switched data services). The application server 930 can also be configured to support one or more communication services (e.g., VoIP sessions, group communication sessions, etc.) for the UE 902 and UE 904 via the CN 924. The application server 930 may communicate with the CN 924 through an IP communications interface 932.

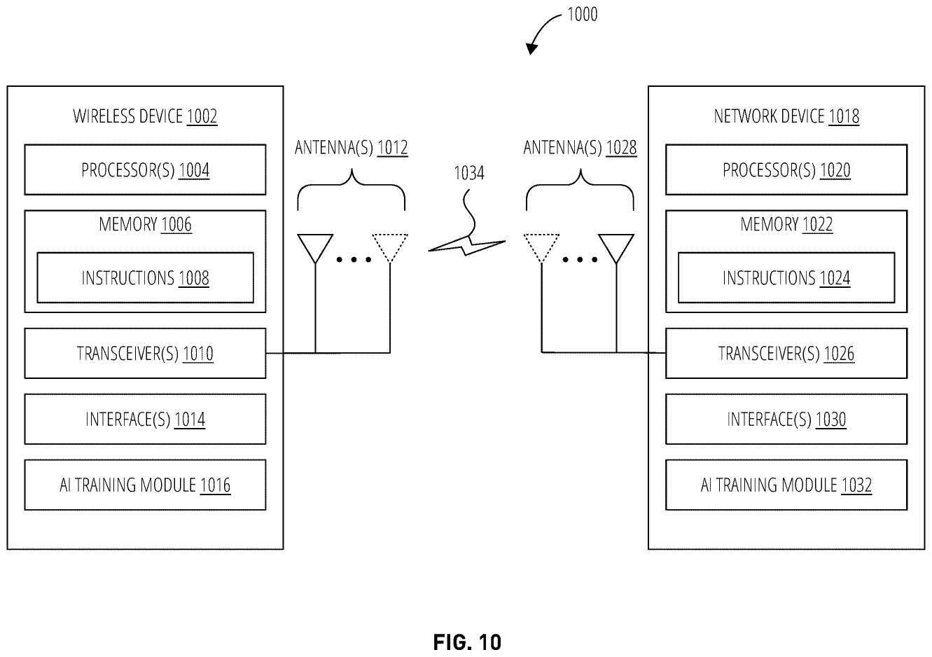

FIG. 10 illustrates a system 1000 for performing signaling 1034 between a wireless device 1002 and a network device 1018, according to embodiments disclosed herein. The system 1000 may be a portion of a wireless communications system as herein described. The wireless device 1002 may be, for example, a UE of a wireless communication system. The network device 1018 may be, for example, a base station (e.g., an eNB or a gNB) of a wireless communication system.

The wireless device 1002 may include one or more processor(s) 1004. The processor(s) 1004 may execute instructions such that various operations of the wireless device 1002 are performed, as described herein. The processor(s) 1004 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 1002 may include a memory 1006. The memory 1006 may be a non-transitory computer-readable storage medium that stores instructions 1008 (which may include, for example, the instructions being executed by the processor(s) 1004). The instructions 1008 may also be referred to as program code or a computer program. The memory 1006 may also store data used by, and results computed by, the processor(s) 1004.

The wireless device 1002 may include one or more transceiver(s) 1010 that may include radio frequency (RF) transmitter and/or receiver circuitry that use the antenna(s) 1012 of the wireless device 1002 to facilitate signaling (e.g., the signaling 1034) to and/or from the wireless device 1002 with other devices (e.g., the network device 1018) according to corresponding RATs.

The wireless device 1002 may include one or more antenna(s) 1012 (e.g., one, two, four, or more). For embodiments with multiple antenna(s) 1012, the wireless device 1002 may leverage the spatial diversity of such multiple antenna(s) 1012 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 1002 may be accomplished according to precoding (or digital beamforming) that is applied at the wireless device 1002 that multiplexes the data streams across the antenna(s) 1012 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 1002 may implement analog beamforming techniques, whereby phases of the signals sent by the antenna(s) 1012 are relatively adjusted such that the (joint) transmission of the antenna(s) 1012 can be directed (this is sometimes referred to as beam steering).

The wireless device 1002 may include one or more interface(s) 1014. The interface(s) 1014 may be used to provide input to or output from the wireless device 1002. For example, a wireless device 1002 that is a UE may include interface(s) 1014 such as microphones, speakers, a touchscreen, buttons, and the like in order to allow for input and/or output to the UE by a user of the UE. Other interfaces of such a UE may be made up of made up of transmitters, receivers, and other circuitry (e.g., other than the transceiver(s) 1010/antenna(s) 1012 already described) that allow for communication between the UE and other devices and may operate according to known protocols (e.g., Wi-Fi®, Bluetooth®, and the like).

The wireless device 1002 may include an AI training module 1016. The AI training module 1016 may be implemented via hardware, software, or combinations thereof. For example, the AI training module 1016 may be implemented as a processor, circuit, and/or instructions 1008 stored in the memory 1006 and executed by the processor(s) 1004. In some examples, the AI training module 1016 may be integrated within the processor(s) 1004 and/or the transceiver(s) 1010. For example, the AI training module 1016 may be implemented by a combination of software components (e.g., executed by a DSP or a general processor) and hardware components (e.g., logic gates and circuitry) within the processor(s) 1004 or the transceiver(s) 1010.

The AI training module 1016 may be used for various aspects of embodiments disclosed herein.

The network device 1018 may include one or more processor(s) 1020. The processor(s) 1020 may execute instructions such that various operations of the network device 1018 are performed, as described herein. The processor(s) 1020 may include one or more baseband processors implemented using, for example, a CPU, a DSP, an ASIC, a controller, an FPGA device, another hardware device, a firmware device, or any combination thereof configured to perform the operations described herein.

The network device 1018 may include a memory 1022. The memory 1022 may be a non-transitory computer-readable storage medium that stores instructions 1024 (which may include, for example, the instructions being executed by the processor(s) 1020). The instructions 1024 may also be referred to as program code or a computer program. The memory 1022 may also store data used by, and results computed by, the processor(s) 1020.

The network device 1018 may include one or more transceiver(s) 1026 that may include RF transmitter and/or receiver circuitry that use the antenna(s) 1028 of the network device 1018 to facilitate signaling (e.g., the signaling 1034) to and/or from the network device 1018 with other devices (e.g., the wireless device 1002) according to corresponding RATs.

The network device 1018 may include one or more antenna(s) 1028 (e.g., one, two, four, or more). In embodiments having multiple antenna(s) 1028, the network device 1018 may perform MIMO, digital beamforming, analog beamforming, beam steering, etc., as has been described.

The network device 1018 may include one or more interface(s) 1030. The interface(s) 1030 may be used to provide input to or output from the network device 1018. For example, a network device 1018 that is a base station may include interface(s) 1030 made up of transmitters, receivers, and other circuitry (e.g., other than the transceiver(s) 1026/antenna(s) 1028 already described) that enables the base station to communicate with other equipment in a core network, and/or that enables the base station to communicate with external networks, computers, databases, and the like for purposes of operations, administration, and maintenance of the base station or other equipment operably connected thereto.

The network device 1018 may include an AI training module 1032. The AI training module 1032 may be implemented via hardware, software, or combinations thereof. For example, the AI training module 1032 may be implemented as a processor, circuit, and/or instructions 1024 stored in the memory 1022 and executed by the processor(s) 1020. In some examples, the AI training module 1032 may be integrated within the processor(s) 1020 and/or the transceiver(s) 1026. For example, the AI training module 1032 may be implemented by a combination of software components (e.g., executed by a DSP or a general processor) and hardware components (e.g., logic gates and circuitry) within the processor(s) 1020 or the transceiver(s) 1026.

The AI training module 1032 may be used for various aspects of embodiments disclosed herein.

Embodiments contemplated herein include an apparatus comprising means to perform one or more elements of the UE methods disclosed herein. This apparatus may be, for example, an apparatus of a UE (such as a wireless device 1002 that is a UE, as described herein).

Embodiments contemplated herein include one or more non-transitory computer-readable media comprising instructions to cause an electronic device, upon execution of the instructions by one or more processors of the electronic device, to perform one or more elements of the UE methods disclosed herein. This non-transitory computer-readable media may be, for example, a memory of a UE (such as a memory 1006 of a wireless device 1002 that is a UE, as described herein).

Embodiments contemplated herein include an apparatus comprising logic, modules, or circuitry to perform one or more elements of the UE methods disclosed herein. This apparatus may be, for example, an apparatus of a UE (such as a wireless device 1002 that is a UE, as described herein).

Embodiments contemplated herein include an apparatus comprising: one or more processors and one or more computer-readable media comprising instructions that, when executed by the one or more processors, cause the one or more processors to perform one or more elements of the UE methods disclosed herein. This apparatus may be, for example, an apparatus of a UE (such as a wireless device 1002 that is a UE, as described herein).

Embodiments contemplated herein include a signal as described in or related to one or more elements of the UE methods disclosed herein.

Embodiments contemplated herein include a computer program or computer program product comprising instructions, wherein execution of the program by a processor is to cause the processor to carry out one or more elements of the UE methods disclosed herein. The processor may be a processor of a UE (such as a processor(s) 1004 of a wireless device 1002 that is a UE, as described herein). These instructions may be, for example, located in the processor and/or on a memory of the UE (such as a memory 1006 of a wireless device 1002 that is a UE, as described herein).

Embodiments contemplated herein include an apparatus comprising means to perform one or more elements of the network node methods disclosed herein. This apparatus may be, for example, an apparatus of a base station (such as a network device 1018 that is a base station, as described herein).

Embodiments contemplated herein include one or more non-transitory computer-readable media comprising instructions to cause an electronic device, upon execution of the instructions by one or more processors of the electronic device, to perform one or more elements of the network node methods disclosed herein. This non-transitory computer-readable media may be, for example, a memory of a base station (such as a memory 1022 of a network device 1018 that is a base station, as described herein).

Embodiments contemplated herein include an apparatus comprising logic, modules, or circuitry to perform one or more elements of the network node methods disclosed herein. This apparatus may be, for example, an apparatus of a base station (such as a network device 1018 that is a base station, as described herein).

Embodiments contemplated herein include an apparatus comprising: one or more processors and one or more computer-readable media comprising instructions that, when executed by the one or more processors, cause the one or more processors to perform one or more elements of the network node methods disclosed herein. This apparatus may be, for example, an apparatus of a base station (such as a network device 1018 that is a base station, as described herein).

Embodiments contemplated herein include a signal as described in or related to one or more elements of the network node methods disclosed herein.

Embodiments contemplated herein include a computer program or computer program product comprising instructions, wherein execution of the program by a processing element is to cause the processing element to carry out one or more elements of the network node methods disclosed herein. The processor may be a processor of a base station (such as a processor(s) 1020 of a network device 1018 that is a base station, as described herein). These instructions may be, for example, located in the processor and/or on a memory of the base station (such as a memory 1022 of a network device 1018 that is a base station, as described herein).

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A method for a network node, the method comprising:
receiving a training dataset from a user equipment (UE), the training dataset comprising a set of inputs for an encoder for channel state information (CSI) feedback, a corresponding set of latent space representations, and a reference to a source of the training dataset;
parsing the training dataset to determine the set of inputs, the set of latent space representations, and the reference to the source;
inputting the set of latent space representations and the reference to the source into an artificial intelligence (AI) decoder for CSI feedback, and
training a decoder model for the AI decoder to output a target CSI that matches the set of inputs, wherein the decoder model is associated with the reference to the source of the training dataset.

2. The method of claim 1, wherein the reference to the source comprises a dataset-identification (ID).

3. The method of claim 2, wherein the dataset-ID is included as a prefix or a post-fix to the latent space representations.

4. The method of claim 2, further comprising training a second decoder model for the AI decoder based on a second training dataset with a different dataset-ID.

5. The method of claim 2, further comprising mapping the dataset-ID to the decoder model.

6. The method of claim 1, wherein the reference to the source is embedded into the latent space representations.

7. The method of claim 1, further comprising determining a decoder model for the AI decoder based on the reference to the source.

8. The method of claim 1, further comprising:
receiving the CSI feedback from the UE;
determining that the UE corresponds to the reference to the source;
decoding the CSI feedback by applying the decoder model; and
altering a transmission based on the CSI feedback.

9. The method of claim 1, further comprising consolidating the training dataset with other datasets that use similar input and latent space labeling.

10. The method of claim 1, sending, to the UE, a decoder model-ID for the CSI feedback.

11. A method for a user equipment (UE), the method comprising:
training an artificial intelligence (AI) encoder for channel state information (CSI) feedback;
generating a training dataset for an AI decoder of a network node, wherein the training dataset comprises a set of inputs used to train the AI encoder, a set of latent space representations output by the AI encoder, and a dataset-identification (ID), wherein the dataset-ID and the latent space representations are fed into the AI decoder of the network node for training; and
sending the training dataset to the network node.

12. The method of claim 11, wherein the dataset-ID is included as a prefix or a post-fix to the latent space representations.

13. The method of claim 11, further comprising encoding and sending CSI feedback using the AI encoder.

14. The method of claim 11, further comprising receiving, from the network node, a decoder model-ID for CSI feedback.

15. A user equipment (UE) apparatus comprising:
a processor; and
a memory storing instructions that, when executed by the processor, configure the UE apparatus to:
receive a training dataset from a network node, the training dataset comprising a set of inputs, a corresponding set of latent space representations, and a reference to a source of the training dataset;
parse the training dataset to determine the set of inputs, the set of latent space representations, and the reference to the source;
feed the reference to the source and the inputs into an artificial intelligence (AI) encoder for CSI feedback, and
train an encoder model for the AI encoder to output the set of latent space representations, wherein the encoder model is associated with the reference to the source of the training dataset.

16. The UE apparatus of claim 15, wherein the reference to the source comprises a dataset-identification (ID).

17. The UE apparatus of claim 16, wherein the dataset-ID is included as a prefix or a post-fix to the latent space representations.

18. The UE apparatus of claim 16, wherein the instructions further configure the UE apparatus to train a second encoder model for the AI encoder based on a second training dataset with a different dataset-ID.

19. The UE apparatus of claim 16, wherein the instructions further configure the UE apparatus to map the dataset-ID to the encoder model.

20. The UE apparatus of claim 15, wherein the reference to the source is embedded into the latent space representations.
